(19) United States
(12) Patent Application Publication
(10) Pub. No.: US 2006/0131852 A1
(43) Pub. Date: Jun. 22, 2006

(54) Gas bag module with a discharge opening

(75) Inventors: Helga Heist, Laufach (DE); Martin Kreuzer, Kleinwallstadt (DE); Markus Keutz, Rossdorf (DE); Michael Lehmann, Aschaffenburg (DE); Joachim Fellhauer, Nilkheim (DE); Lutz Haese, Aschaffenburg (DE); Michael Schneider, Sulzbach (DE); Michael Deckenhoff, Duelmen (DE); Matthias Helmstetter, Aschaffenburg (DE); Klaus Freudenberger, Aschaffenburg (DE); Thomas Britz, Bessenbach (DE); Marcus Magoley, Aschaffenburg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive safety systems GmbH

(21) Appl. No.: 11/302,104

(22) Filed: Dec. 13, 2005

(30) Foreign Application Priority Data
Dec. 16, 2004 (DE) 20 2004 019 446.5

(51) Int. Cl. B60R 21/26

(52) U.S. Cl. 280/736

(57) ABSTRACT

A gas bag module for a vehicle occupant restraint device includes a rigid component (10). The rigid component (10) has a discharge opening (12) formed therein through which gas can escape. A control arrangement through which gas can pass is provided at the discharge opening (12). The control arrangement is designed so that the quantity of the gas passing through depends on the speed of flow of the gas.

### TECHNICAL FIELD

The invention relates to a gas bag module for a vehicle occupant restraint device, in particular to a gas bag module with a discharge opening.

### BACKGROUND OF THE INVENTION

Basically, in a gas bag module the gas bag is to be filled as quickly as possible with the gas which is generated by the gas generator. In particular cases it is, of course, desirable to adapt the quantity of gas or the internal pressure in the gas bag to particular conditions. For this purpose, discharge openings which are able to be freed can be provided in the gas bag itself or in rigid components of the gas bag module.

From US 2004/0 051 285 A1 a gas bag module is known with valve flaps which can close or free discharge openings formed in a gas generator carrier. The valve flaps are connected by limiting straps to a part of the gas bag fabric facing the vehicle occupant. On activation of the gas bag module, the valve flaps are initially in the open position, so that gas can escape. If the unfolding gas bag comes into contact very early with the vehicle occupant, the discharge openings remain open. Thereby, the pressure of the unfolding gas bag and hence the force exerted onto the vehicle occupant, is reduced. If, on the other hand, the vehicle occupant is in a position which is further away from the gas bag module, the discharge openings are closed in the course of the further unfolding by the limiting straps, against the internal pressure of the gas bag, so that no more gas can flow off. US 2004/0 051 285 A1 also mentions another design according to which the valve flaps are initially closed and only open with increasing internal pressure of the gas bag.

It is an object of the invention to provide a gas bag module with a discharge opening, the effective cross-section of which regulates itself by simple means.

### BRIEF SUMMARY OF THE INVENTION

The gas bag module for a vehicle occupant restraint device according to the invention includes a rigid component. The rigid component has a discharge opening formed therein through which gas can escape. A control arrangement through which gas can pass is provided at the discharge opening. The control arrangement is designed so that the quantity of gas passing through depends on the speed of flow of the gas.

The control arrangement provided according to the invention makes possible in a simple manner an automatic adaptation of the outflowing quantity of gas as a function of the speed of flow of the gas.

According to a first embodiment of the invention, this is achieved by a flow cross-section narrowing with increasing speed of flow. For this, the invention makes provision that the control arrangement comprises two plates lying opposite each other, a flow channel being formed between the plates and at least one of the plates being mounted elastically. With an increasing speed of flow, an underpressure builds up in the flow channel, which causes the elastically mounted plate to move towards the other plate. Thereby, the flow channel narrows so that the effective discharge cross-section is automatically made smaller.

Preferably the elastically mounted plate is mounted on at least one spring.

The effect of the flow channel narrowing owing to the underpressure can be increased in that both plates are mounted elastically, i.e. both plates can move towards each other.

According to a second embodiment of the invention, the control arrangement comprises a labyrinth-like flow channel. In this case, the invention makes use of the effect that in such a flow channel the gas flow becomes more turbulent with increasing speed of flow. The turbulences prevent the discharge of the gas, so that here also the outflowing quantity of gas is automatically adapted to the speed of flow.

### BRIEF DESCRIPTION OF THE DRAWINGS

FIG. 1 shows a portion of a gas bag module according to the invention in accordance with a first embodiment; and

FIG. 2 shows a portion of a gas bag module according to the invention in accordance with a second embodiment.

### DETAILED DESCRIPTION OF THE PREFERRED EMBODIMENTS

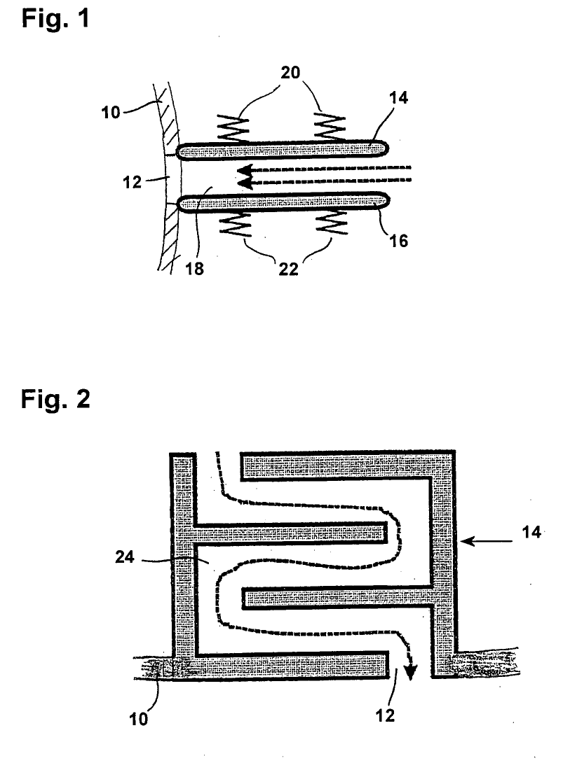

In FIG. 1 a rigid component 10 of a gas bag module is illustrated, which may for example be a gas generator carrier or a wall of a module housing. In the rigid component 10 a discharge opening 12 is formed, through which a portion of the gas can escape which is provided for filling the gas bag of the module. At the discharge opening 12, two plates 14, 16 are arranged which lie opposite each other in parallel. Between the two plates 14, 16 a flow channel 18 is formed, opening out into the discharge opening 12. The two plates 14, 16 are mounted elastically on springs 20, 22, so that they are movable perpendicularly to the plane of the plate.

The springs 20, 22 are designed so that with a low speed of flow, the plates 14, 16 largely maintain their position. At a high speed of flow, however, a noticeable underpressure occurs between the plates. The underpressure generates forces onto the plates 14, 16 which causes the plates 14, 16 to move towards each other, whereby the cross-section of the flow channel 18 is reduced. The elastically mounted plates 14, 16 therefore represent a control arrangement by which the quantity of the outflowing gas is automatically adapted to the speed of flow of the gas.

FIG. 2 shows another embodiment of the invention, in which likewise the outflowing quantity of gas is regulated as a function of the speed of flow. Here, also, the discharge opening 12 is formed in a rigid component 10 of the gas bag module. In front of the discharge opening 12, a structure 14 is provided, through which a labyrinth-like flow channel 24 is formed, which opens out into the discharge opening 12. This structure 14 also represents a control arrangement.

The flow through the flow channel 24 is laminar at a low speed of flow, so that the emergence of gas through the discharge opening 12 is only slightly impeded. At a higher speed of flow, the flow becomes increasingly turbulent owing to physical laws. Vortices form, which act contrary to the direction of flow. The flow resistance produced automatically in this way limits the outflowing quantity of gas.

Therefore, in both embodiments, the effective cross-section of the discharge opening 12 automatically adjusts itself as a function of the speed of flow.

1. A gas bag module for a vehicle occupant restraint device, the gas bag module including a rigid component having a discharge opening formed therein through which gas can escape, a control arrangement through which gas can pass being provided at the discharge opening, the control arrangement being designed so that the quantity of the gas passing through depends on the speed of flow of the gas.

2. The gas bag module according to claim 1, wherein the control arrangement comprises two plates lying opposite each other, a flow channel being formed between the plates, and at least one of the plates being mounted elastically.

3. The gas bag module according to claim 2, wherein the elastically mounted plate is mounted on at least one spring.

4. The gas bag module according to claim 2, wherein both plates are mounted elastically.

5. The gas bag module according to claim 1, wherein the control arrangement comprises a labyrinth-like flow channel.
